(19) United States
(12) Patent Application Publication
(10) Pub. No.: US 2011/0307266 A1
(43) Pub. Date: Dec. 15, 2011

(54) REAL-TIME INTERACTIVE PROACTIVE, AUTOMATED PATIENT TRACKING AND PATIENT/HOSPITAL STAFF/CARE PROVIDER ENGAGEMENT SYSTEM AND METHOD

(76) Inventor: Terry L. Henley, Troy, OH (US)

(21) Appl. No.: 13/117,559

(22) Filed: May 27, 2011

Related U.S. Application Data
(63) Continuation-in-part of application No. 11/748,032, filed on May 14, 2007, now abandoned.

(51) Int. Cl. G06Q 50/00

(52) U.S. Cl. 705/2

(57) ABSTRACT

An interactive courtesy call within a hospital includes admitting a patient and generating unique patient id data and admission time and date data and assigning the patient to a unit for treatment, transferring said data to a computer based device which has software thereon for conducting an interactive telephonic courtesy call with the patient, wherein the software obtains unique patient id data and admission time and date data and monitors location of the patient, treating the patient subsequent to admission and returning the patient to a patient room having a phone, generating one of a predetermined question specific to the treatment or related to hospital facility and initiating an interactive telephonic courtesy call with the patient through the phone by use of a personal prerecorded voice message from an employee of the hospital, and real-time transmitting result data obtained through the interactive telephonic courtesy call to a hospital attendant.

This is a continuation-in-part of U.S. Ser. No. 11/748032 filed May 14, 2007.

### FIELD OF INVENTION

This invention relates generally to a method and system for conducting courtesy calls which are employed in medical the medical field to enhance management effectiveness. More specifically, the invention relates to a method and system for conducting a real-time interactive courtesy call system that produces real-time data derived directly from patients to enhance medical care, promote patient loyalty and engage more cohesive unity between patients and care providers.

### BACKGROUND

Traditional survey approaches can be costly due to the criteria used in developing such surveys, such as supplies and survey provider rates. Several factors of quality, cost, and access must be evaluated simultaneously to assess how well and at what cost a hospital or doctor provides medical care. Current systems and methods of determining these factors are lacking and do not provide significantly useful information to the hospital manager.

A primary focus of a hospital administrator is maintaining a loyal patient (customer) base and increasing the number of new patients (customers). Maintaining loyal patients continually requires that the hospital administrator evaluate why such loyal patients decide to use its hospital instead of a competitor's. The question defines the equity of the hospital. Hospital administrators understand that loyalty is important to maintaining a successful hospital. Loyalty is a direct function of customer satisfaction and thus after discharge surveys are currently the means to determine satisfaction and maintain loyalty.

Consider the choice of hospitals in a given geographic area. If customer-patients are satisfied, they will return for future treatments and recommend the hospital to their friends. Patient loyalty translates into continued business for the hospital. Their dissatisfaction means moving their business reducing the revenue of the hospital.

The equity of a hospital is in large part a function of loyalty and reputation provided by patients using its services. A hospital which develops substantial patient equity is more protected from competition or changes in the marketplace. Survey evaluation of such equity is desirable so that informed marketing and business decisions regarding the service can be made, particularly when surveys can be performed cost effectively.

Consumer view points as to medical care, particularly at hospitals, are commonly evaluated using hospital consumer assessment of health of health providers (HCAHPS) survey which is known in the industry. A typical paradigm is to consider the choice of hospitals in a given geographic area and whether customer-patients are satisfied, based on their return for future treatments and/or recommend the facilities to their friends. CMS (Centers for Medicare and Medicaid Services) publishes results on the Internet to assist patients in selecting the best hospital for their healthcare needs.

Real time effective information obtained from HCAHPS survey is not possible. Patient's typically fear providing accurate information direct to hospital staff while in the hospital undergoing treatment, for fear of receiving bad treatment. Thus, there remains a need for a less direct approach to receive information from a patient in real time, while the patient is in the hospital and the system needs to employ a logic tied to a real-time patient stay related event.

Patient loyalty translates into continued business for the hospital. Dissatisfaction results in moving their business to the other competing facilities thereby reducing the revenue of the hospital. It is therefore imperative to maintain satisfied, loyal customers who will continue to use the hospital's services.

While current approaches have some value, there remains a need to improve the system and method of engaging/uniting patients and hospital staff members to improve hospital management and patient care. The present invention accomplishes these goals.

### SUMMARY OF INVENTION

It is an object to improve data collection in the medical field.

It is another object to provide a real-time data collection method and system.

It is also an object to provide an automated courtesy call that reaches out to patients while they are in the hospital thereby providing an indirect approach to soliciting feedback from patients that are typically not comfortable with sharing their opinions.

It is also an object to improve patient psychological state of attitude.

It is an object to improve patient loyalty.

It is still another object to increase hospital business through patient referrals.

Yet another object of the invention is to provide a system and method that evaluates the quality, cost and access of treatment facilities and identify deficiencies thereby.

The present invention is intended to provide real-time data derived directly from the patient while they are in the hospital, and that data can be compared with the “after discharge” HCAHPS survey information so that improvements in medical care can be made in the hospitals in both an immediate and long-term manner. For example, the invention provides for such results to be immediately used to view patient needs and desires and history and administer care as desired. By doing so, the hospital can gain favorable patient perceptions, which is likely to impart loyalty and induce recommendations leading to future customers.

Accordingly, the present invention is directed to a method of engaging patients to share patient satisfaction information with hospital staff and administration. The method includes the steps of (a) placing a courtesy call to the patients' bedside phone. The system software obtains a unique patient id for the patient and tracks the location of the patient within the hospital and keeps track of the location of the patient within the hospital throughout admission transfer and discharge, (b) treating the patient (c) subsequent to the treatment generating one of a predetermined question specific to the treatment and a predetermined question related to each hospital unit/point of care (d) initiating a courtesy call to the patient through the phone by use of a personal prerecorded voice message from an employee of the hospital and conducting the survey using one of the predetermined questions and (e) real-time transmitting results obtained through the system to an attendant within the hospital.

Another aspect of the invention includes tracking the location of the patient within the hospital using the patient id and subsequent to a predetermined time period initiating a follow up courtesy call to the patient through the phone by use of a personal prerecorded voice message from an employee of the hospital using one of the predetermined questions and real-time transmitting results to an attendant within the hospital.

The method can also include the step of generating a real-time report. A further step can be dispatching a predetermined attendant in response to one or more hospital staff members.

The system software can be equipped to prompt the patient through a series of topics and to indicate by predetermined numbers on the phone a level of satisfaction for the particular topic. Such topics can include medical care, nursing services, physician services, overall treatment, food, hospital amenities, admission process, room condition, cost, cleaning and janitorial service, etc. The system software can be equipped to send a signal, e.g., through a network, to a particular attendant upon the patient providing a particular response, while engaged, such as dissatisfaction with the food whereby an electronic message can be sent to the hospital administrator as well as the cook to address the issue. Further, system software is equipped to gather data quantifying quality, cost, and assess performance characteristics of each, display the quality, cost and assess performance characteristic simultaneously on a graph to indicate thereby strong and weak quality and cost and assess performance characteristics, and identify the strong and weak quality and cost and assess performance characteristics of each.

The method provides a system employing the same. The system software provides logic wherein based upon a predetermined time after admission of a patient, or at a predetermined time selected by a unit within a hospital, or after a response received, a predetermined message is sent to an attendant suggesting a course action for the attendant based on the response.

The system includes:

a secure VPN connection to the live hospital ADT (adds, discharges, transfers) data for obtaining unique patient id data and admission time and date data and assigning a patient to a unit within the hospital for treatment such that the unit data is associated with the unique patient id data and admission time and date data;

a patient room having a phone;

a computer based device remotely located from the hospital and communicably connected to the ADT data which has telephony software thereon for conducting a telephonic communication with the patient, wherein the system software obtains the unique patient id data and admission time and date data and wherein the system software monitors the location of the patient within the hospital throughout admission transfer and discharge and subsequent to a predetermined event including one of time elapsed and treatment completion of the patient wherein the patient is disposed in a patient room the system software generates one of a predetermined question specific to the treatment and a predetermined question related to hospital facility and initiates a telephone courtesy call to the patient through said phone by use of a personal prerecorded voice message from an employee of the hospital and conducts the courtesy call using one of the predetermined questions and real-time transmits the data obtained through the telephone courtesy call to an attendant within the hospital.

These objects together with other objects, features and advantages of the invention will become more readily apparent from the following detailed description when taken in conjunction with the accompanying drawings wherein like elements are given like reference numerals throughout.

### BRIEF DESCRIPTION OF THE DRAWINGS

FIG. 1 is a schematic of the present invention.

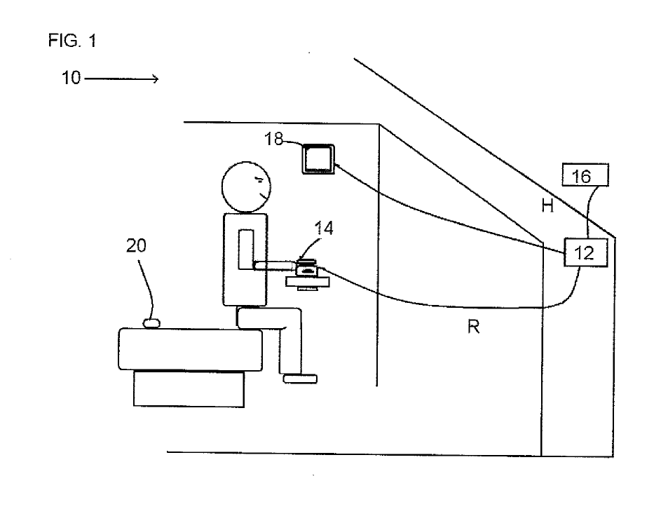

FIG. 2 is a screen shot depicting a monthly comparison of the department rank from year to year.

FIG. 3 depicts a daily completion report for surveys completed by patient.

FIG. 4 depicts how tickets are searched for using the invention.

FIG. 5 depicts a trouble ticket using the invention.

FIG. 6 depicts a courtesy call record using the invention.

FIG. 7 depicts a flow chart of the operative steps of performing the invention.

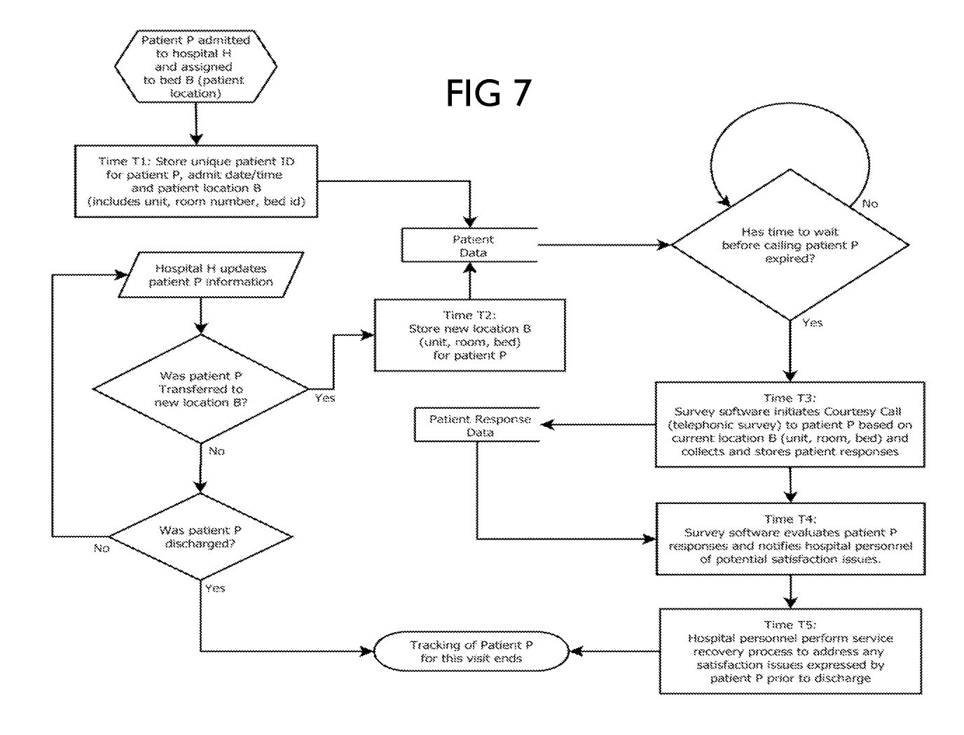

### DETAILED DESCRIPTION OF THE PREFERRED EMBODIMENT

The present invention is a process and system of modeling the factors of quality, cost, and access in such a manner as to provide a holistic description of the effectiveness of medical treatment data from a variety of computerized databases and incorporating patient perceptions of medical care through the use of real-time interactive, proactive, automated patient tracking and patient/hospital staff/care provider engagement system and method via a courtesy call placed to the patients' bedside phone. This allows effectiveness of different groups of medical care facilities to be compared to each other. Deficiencies in performance are readily identified through this process, permitting goals and targets to be established that provide direction for medical administrators to enhance medical care at their treatment facilities.

Referring now to the present invention, the system and method within a hospital is generally referred to by the numeral 10. The system 10 can preferably include a computer based device 12 which can be operably disposed in a hospital h or at a remote site. The computer based device 12 can be operably connected to a phone 14 which can be disposed in room r, such as a patient room, of the hospital H. In connection with one aspect of the instant invention, phone 14 is disposed in each patient room R. the computer based device 12 can be equipped to communicate with the other computers 16 located local or remotely in order to transact and process information running standard operating system software such as windows, linux, or unix.

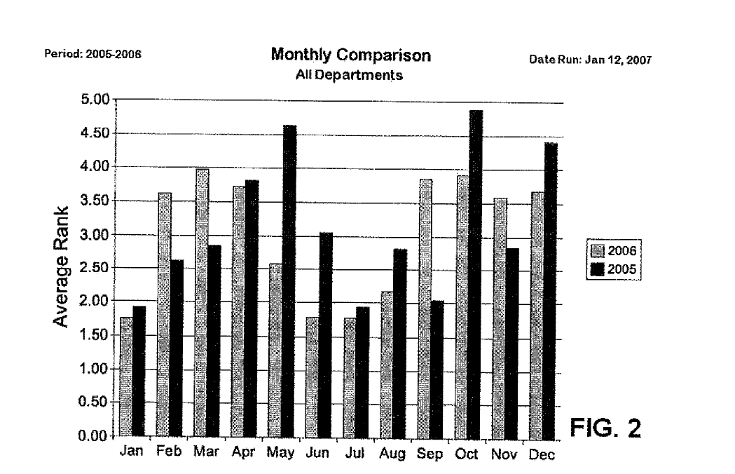

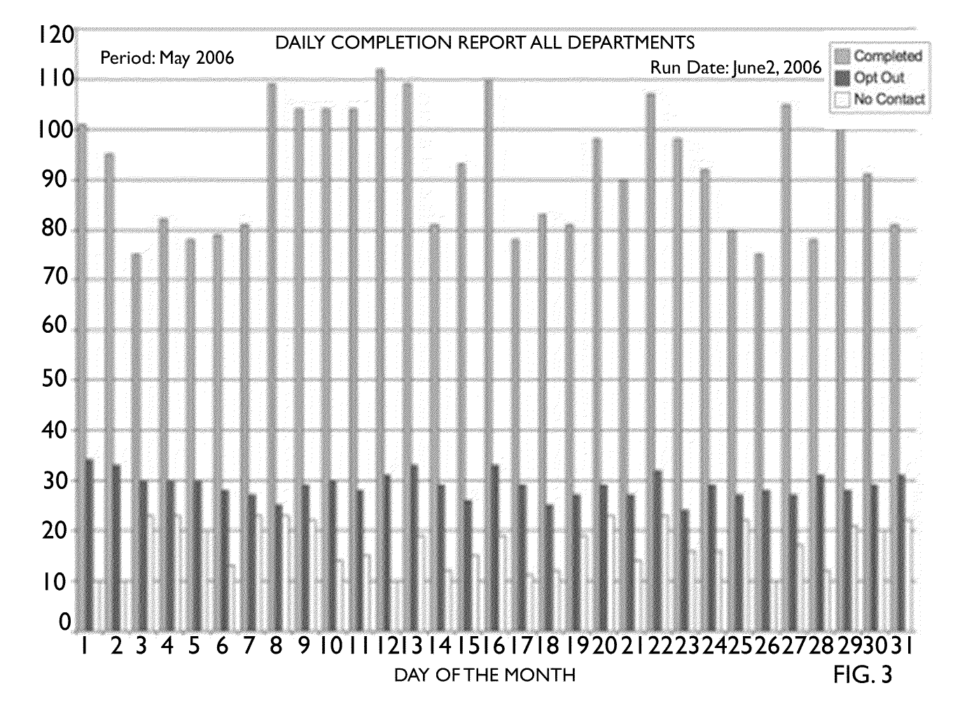

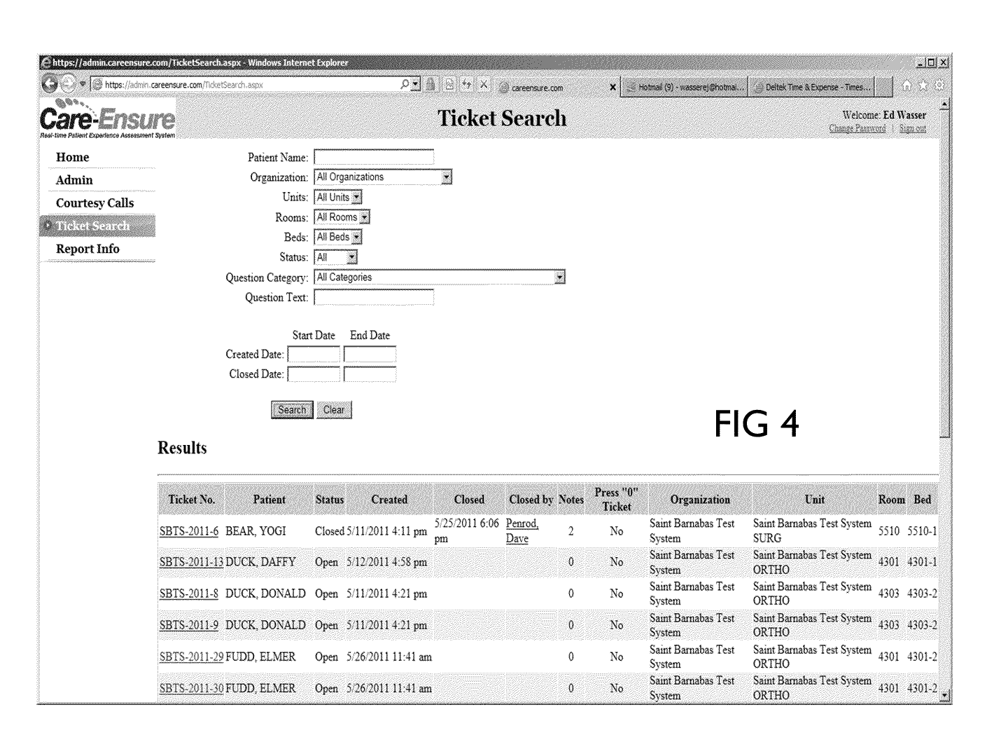

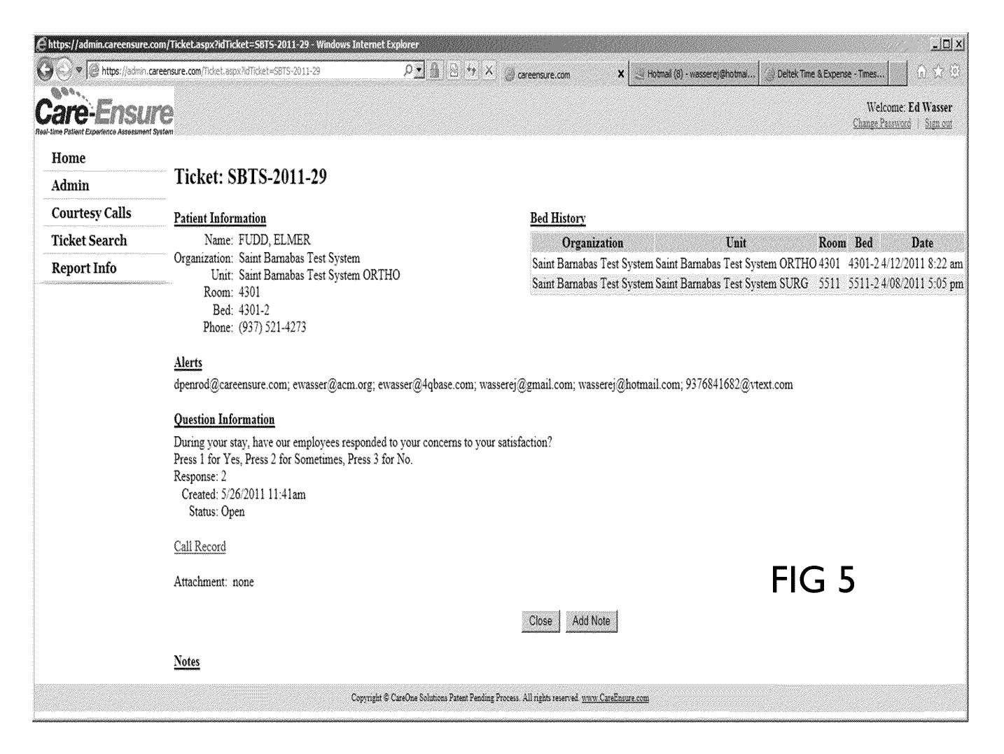

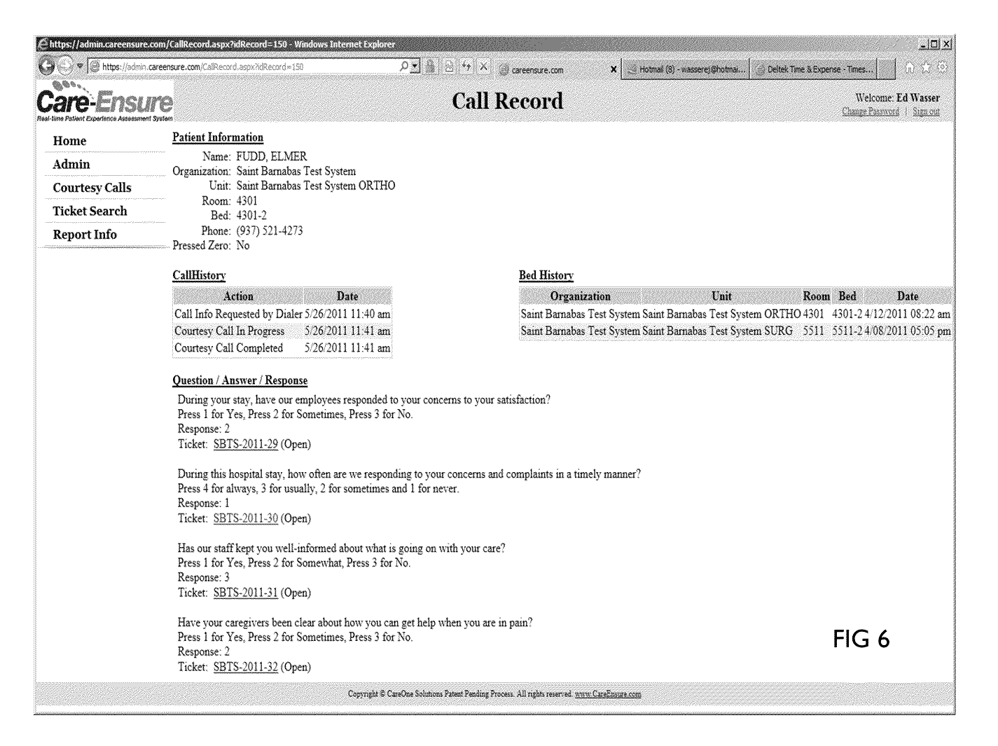

It is understood that computer based device 12 can be equipped with conventional hardware, such as processor, memory, power source, keyboard, monitor, mouse, printer, etc., as known in the art. Further, computer based device 12 includes automated telephonic software for enabling thereon for conducting a telephonic courtesy call with the patient, conducting the telephone courtesy call with the patient through the phone and real-time transmitting results obtained through the system to an attendant within the hospital h. The system software is equipped to generate real-time reports as seen in FIGS. 2-6. The system software is also equipped to transmit a signal dispatch a predetermined attendant in response to one or more responses obtained through the courtesy call.

The system 10 can preferably include the following steps and elements. Phone 14 is disposed within a patient room within a hospital H. The system software obtains a unique patient id for the patient P and tracks location of the patient P within the hospital H. The patient P is treated and subsequent to the treatment the system software generates either a predetermined question specific to the treatment rendered or a predetermined question related to hospital facility. A telephone courtesy call is initiated by the system software with the patient through the phone 14 by use of a personal prerecorded voice message from an employee of the hospital h and conducting the courtesy call using one of the predetermined questions. Responses obtained through the courtesy call are transmitted in real-time by the system software to an attendant within the hospital h.

Another aspect of the invention includes tracking the location of the patient p within the hospital h using the patient id and subsequent to a predetermined time period. The system is capable of initiating a follow up call with the patient p through the phone 14 by use of a personal prerecorded voice message from an employee of the hospital h and the courtesy call uses one of the predetermined questions. Again, the responses are real-time transmitted to an attendant within the hospital.

The system 10 generates a real-time report. A further aspect includes dispatching a predetermined attendant in response to one or more courtesy call responses.

It is conceived that the system software can be controlled locally or remotely. It is envisioned that the remote server computer 16 can be connected to a plurality of computer based devices 12 which are located at one or more hospitals H. The remote server computer 16 can be equipped to provide a telephonic courtesy call for a particular hospital as well as send site specific signals to the video screen and/or printer signals thereto, wherein the video signals or printer signals can include report messages, attendant response messages, or other information for the particular site. The system software keeps track of the location of the patient within the hospital throughout admission transfer and discharge. Accordingly, the system 10 can include one or more phones 14 operably disposed in one or more hospitals H, connected to the computer based device 12 and optionally the remote server computer 16. It is also envisioned that the phones 14 can be directly linked to a remote call center c to facilitate questions and answers and transactions for a user. Another embodiment can employ television 18 which can likewise be operably connected to the computer 12 to conduct a survey wherein the patient can look at the television and respond to displayed questions thereon using a TV remote control 20.

In one embodiment, the method includes the steps of (a) providing a phone at the hospital which is operably connected to a computer based device having software thereon for conducting a telephonic survey with the patient, (b) conducting the telephone survey with the patient through the phone and (c) real-time transmitting results obtained through the telephone survey to an attendant within the hospital. The method can also include the step of generating a real-time report. A further step can be dispatching a predetermined attendant in response to one or more survey responses. In another embodiment, the method includes the steps of (a) providing a television at the hospital which is operably connected to a computer based device having survey software thereon for conducting a television survey with the patient, (b) conducting the television survey with the patient through the television and (c) real-time transmitting results obtained through the television survey to an attendant within the hospital.

The system software can be equipped to prompt the patient through a series of topics and to indicate by predetermined numbers on the phone a level of satisfaction for the particular topic. For example, the patient can press 4 for always, 3 for usually, 2 for sometimes, 1 for never for each topic. Such topics can include medical care, nursing services, physician services, overall treatment, food, hospital amenities, phone service, television service, admission process, room condition, cost, cleaning and janitorial service, etc. The system software can be equipped to send a signal, e.g., through a network, to a particular attendant upon the patient providing a particular response, such as dissatisfaction with the food whereby an electronic message can be sent to the hospital administrator as well as the cook to address the issue (described in the healthcare industry as—service recovery). Further, system software can be equipped to gather data quantifying quality, cost, and assess performance characteristics of each, display the quality, cost and access performance characteristic simultaneously on a graph to indicate thereby strong and weak quality, cost and access performance characteristics, and identify the strong and weak quality, cost and access performance characteristics of each. Further, the software can prompt for other responses, such as whether the treatment is elective and non-elective treatment.

Again, it is also considered an aspect of the invention to provide for evaluating effectiveness of service of one or more hospitals. This evaluation includes gathering data, quantifying quality, cost, and assessing performance characteristics of each. This information can be displayed or produced in a manner currently known in the art to assess the quality, cost and assess performance characteristics and identify each for the hospital.

The present invention thus provides not only a feedback system with qualitative and quantitative aspects, but additionally provides a real-time response as a function of the system to enable each area to ascertain performance and continually improve satisfaction. Thus, the timing of the research is more likely to generate a better indication of satisfaction of the patient. A benefit of the invention is that corrective measures can be immediately taken as opposed to reconstructing the information of the personnel involved in treating the patient.

While the instant invention has been shown and described in what is considered to be a practical and preferred embodiments, it is recognized that departures may be made within the spirit and scope of this invention which is, therefore, not to be limited except as set forth in the claims hereinafter and within the doctrine of equivalents.

What is claimed is:

1. A method of conducting telephonic courtesy calls within a hospital, which includes the steps of:
(a) admitting a patient to a hospital and generating unique patient id data and admission time and date data and assigning the patient to a unit within the hospital for treatment;
(b) transferring said data to a computer based device which has software thereon for conducting an interactive telephonic courtesy call with the patient, wherein the system software obtains the unique patient id data and admission time and date data and wherein the system software monitors the location of the patient within the hospital throughout admission transfer and discharge;
(c) treating the patient subsequent to admission and returning the patient to a patient room having a phone.
(d) subsequent to the treatment generating one of a predetermined question specific to the treatment and a predetermined question related to hospital facility and initiating a telephone courtesy call with the patient through the phone by use of a personal prerecorded voice message from an employee of the hospital and conducting the courtesy call using one of the predetermined questions; and
(e) real-time transmitting the result data obtained through the telephone courtesy call to an attendant within the hospital.

2. The method of conducting interactive courtesy calls within a hospital of claim 1, which further includes a step of generating a real-time report.

3. The method of conducting interactive telephonic courtesy calls within a hospital of claim 1, which further includes a step of dispatching a predetermined attendant from the unit in response to the result data.

4. The method of conducting interactive telephonic courtesy calls within a hospital of claim 1, wherein said system software is equipped to prompt the patient through a series of topics and to indicate by predetermined numbers on one of said phone a level of satisfaction for the particular topic.

5. The method of conducting interactive telephonic courtesy calls within a hospital of claim 4, wherein said topics include one of medical care, nursing services, physician services, overall treatment, food, hospital amenities, admission process, room condition, cost, cleaning and janitorial service.

6. The method of conducting interactive telephonic courtesy calls within a hospital of claim 1, wherein said system software is equipped to send a an electronic message to a predetermined attendant within the unit upon the patient providing a particular response during said courtesy call.

7. The method of conducting interactive telephonic courtesy calls within a hospital of claim 1, wherein the software by virtue of tracking the patient id data and subsequent to a predetermined time period calculated from the time and date data, initiating a follow up courtesy call with the patient through the phone by use of a personal prerecorded voice message from an employee of the hospital and conducting the courtesy call using one of the predetermined questions and real-time transmitting the result data obtained to an attendant within the unit of the hospital.

8. The method of conducting interactive telephonic courtesy calls within a hospital of claim 1, wherein said system software is equipped to gather data quantifying quality, cost, and assess performance characteristics of each, display the quality, cost and access performance characteristic simultaneously on a graph to indicate thereby strong and weak quality, cost and access performance characteristics, and identify the strong and weak quality, cost and access performance characteristics of each.

9. A system for conducting interactive telephonic courtesy calls within a hospital, which includes:
a patient room having a bedside phone;
a computer based device remotely located from said hospital and communicably connected to a live hospital patient data ADT feed with said computer based device having telephonic capability to conduct courtesy calls to the patients' bedside phone based upon the system obtaining the unique patient id data and admission time and date data and wherein the system software monitors the location of the patient within the hospital throughout admission transfer and discharge and subsequent to a predetermined event including one of time elapsed and treatment completion of the patient wherein the patient is disposed in a patient room said system software generates one of a predetermined question specific to the treatment and a predetermined question related to hospital facility and initiates a telephone courtesy call with the patient through said phone by use of a personal prerecorded voice message from an employee of the hospital and conducts the courtesy call using one of said predetermined questions. and real-time transmits results data obtained through the courtesy call to an attendant within the hospital.

10. The system for conducting interactive telephonic courtesy calls within a hospital of claim 9, wherein said system software generates a real-time report.

11. The system for conducting interactive telephonic courtesy calls within a hospital of claim 9, wherein said system software sends a dispatch message to a predetermined unit attendant in response to said results data.

12. The system for conducting interactive telephonic courtesy calls within a hospital of claim 9, wherein said system software prompts the patient through a series of topics indicating by predetermined numbers on the phone a level of satisfaction for the particular topic.

13. The system for conducting interactive telephonic courtesy calls within a hospital of claim 12, wherein said topics include one of medical care, nursing services, physician services, overall treatment, food, hospital amenities, admission process, room condition, cost, cleaning and janitorial service.

14. The system for conducting interactive telephonic courtesy calls within a hospital of claim 9, wherein said system software sends an electronic message suggesting a predetermined action to a predetermined attendant upon the patient providing a particular response.

15. The system for conducting interactive telephonic courtesy calls within a hospital of claim 9, wherein said system software gathers data including quantifying quality, cost, and assess performance characteristics of each, display the quality, cost and access performance characteristic simultaneously on a graph to indicate thereby strong and weak quality, cost and access performance characteristics, and identify the strong and weak quality, cost and access performance characteristics of each.
